(19) United States
(12) Patent Application Publication
(10) Pub. No.: US 2016/0062073 A1
(43) Pub. Date: Mar. 3, 2016

(54) IMAGE SENSOR MODULE AND METHOD FOR ADJUSTING FOCUS OF IMAGE SENSOR MODULE

(71) Applicant: HIMAX TECHNOLOGIES LIMITED, Tainan City (TW)

(72) Inventor: Yin-Dong Lu, Tainan City (TW)

(21) Appl. No.: 14/472,331

(22) Filed: Aug. 28, 2014

(51) Int. Cl. G02B 7/02; G02B 7/04; G02B 7/00

(52) U.S. Cl. CPC G02B 7/026; G02B 7/025; G02B 7/003; G02B 7/04

(57) ABSTRACT

According to one embodiment of the present invention, an image sensing module includes a substrate, an image sensor mounted on the substrate, a holder positioned on the substrate, a plurality of lens barrels positioned in the holder, and a plurality of elastic components. Each of the lens barrels holds a lens module, and each of the elastic components is positioned between the holder and the corresponding lens barrel, and exerting forces on the holder and the corresponding lens barrel.

### BACKGROUND OF THE INVENTION

1. Field of the Invention

The present invention relates to an image sensor module, and more particularly, to an image sensor module and a method for adjusting a focus of the image sensor module.

2. Description of the Prior Art

Please refer to FIG. 1, which is a diagram illustrating a prior art flow of assembling an image sensor module and adjusting a focus of the image sensor module. In the first step, an image sensor 120 is fixed with a printed circuit board (PCB) 110 by using glue 112, and a dispenser dispenses thermo glue 122 on the PCB 110. Then in the second step, a holder 130 having a lens module 132 is positioned on the thermo glue 122 and is mounted on the PCB 110, where the lens module 132 may have a plurality of lenses. In the third step, the image sensor module is put into an oven to perform hard curing process, that is to cure the thermo glue 122 to fix the holder 130 with the PCB 110. Finally, in the fourth step, a modulation transfer function (MTF) test is performed, and a focus of the image sensor module is adjusted by adjusting a distance between the lens module 132 and the image sensor 120.

However, because the amount of the thermo glue 122 dispensed on the PCB 110 may not be precisely controlled, and the shape of the thermo glue 122 may be changed due to the hard curing process, the holder 130 may suffer a tilt problem and the images sensed by the image sensor 120 may be blurred. In addition, because the lens module 132 has many lenses, so when the holder 130 suffers the tilt problem, the focus of a portion of lens may not be precisely adjusted.

### SUMMARY OF THE INVENTION

It is therefore an objective of the present invention to provide an image sensor module and a method for adjusting a focus of the image sensor module, to solve the above-mentioned problems.

According to one embodiment of the present invention, an image sensing module comprises a substrate, an image sensor mounted on the substrate, a holder positioned on the substrate, a plurality of lens barrels positioned in the holder, and a plurality of elastic components. Each of the lens barrels holds a lens module, and each of the elastic components is positioned between the holder and the corresponding lens barrel, and exerting forces on the holder and the corresponding lens barrel.

According to another embodiment of the present invention, a method for adjusting a focus of an image sensor module comprises: providing a substrate; providing an image sensor mounted on the substrate; providing a holder positioned on the substrate; putting a plurality of elastic components on holes of the holder; positioning a plurality of lens barrels into the holes of the holder, respectively, to make each of the elastic components is positioned between the holder and the corresponding lens barrel, wherein each of the elastic components exerts forces on the holder and the corresponding lens barrel, and each of the lens barrels holds a lens module; and sliding the lens barrels relative to the holder to adjusting distances between the lens barrels and the image sensor, respectively, to adjusting the focus of the image sensor module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a prior art flow of assembling an image sensor module and adjusting a focus of the image sensor module.

FIGS. 2A and 2B show a diagram illustrating a flow of assembling an image sensor module and adjusting a focus of the image sensor module according to one embodiment of the present invention.

### DETAILED DESCRIPTION

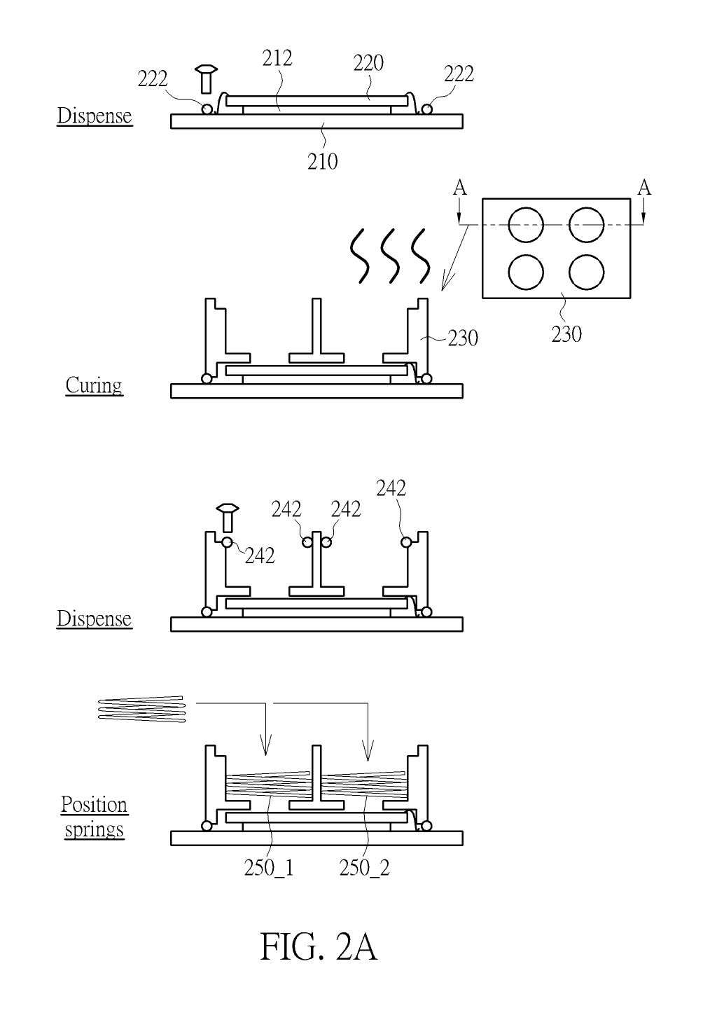

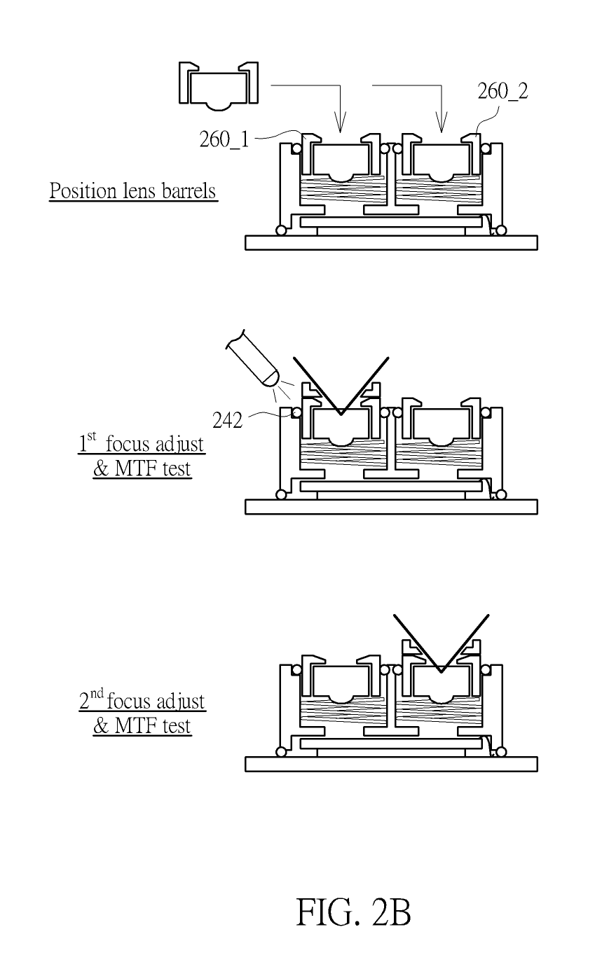

Please refer to FIGS. 2A and 2B, which show a diagram illustrating a flow of assembling an image sensor module and adjusting a focus of the image sensor module according to one embodiment of the present invention. It is noted that provided that the results are substantially the same, the steps are not limited to be executed according to the exact order shown in FIGS. 2A and 2B. Referring to FIGS. 2A and 2B, the flow is described as follows.

In the first step, an image sensor 220 is fixed with a substrate (in this embodiment, the substrate is a PCB 210) by using glue 212, and a dispenser dispenses thermo glue 222 on the PCB 210. In the second step, a holder 230 is positioned on the thermo glue 222, and the holder 230 and the PCB 210 are put into an oven to perform hard curing process to cure the thermo glue 222 to fix the holder 230 with the PCB 210. In this embodiment, the holder 230 shown in FIG. 2A has four holes (FIG. 2A shows the top view and cross-section view of the holder 230), but it's not a limitation of the present invention, in practice, the quantity of the holes of the holder 230 can be designed according to designer's consideration.

After the holder 230 is fixed on the PCB 210, in the third step, a dispenser dispenses glue on inner walls of the holes of the holder 230. In this embodiment, the glue dispensed on the inner walls is ultraviolet rays glue (UV-glue) 242, but the glue can also be other glue such as thermo glue.

In the fourth step, a plurality of elastic components are positioned into the holes of the holder 230, respectively. In this embodiment, each of the elastic components is a compression coil spring 250_1, 250_2, and each hole of the holder 230 has only one compression coil spring. However, in other embodiments of the present invention, the compression coil spring 250_1, 250_2 shown in FIG. 2A can be replaced by any other type of elastic component such as spring leaf.

In the fifth step, a plurality of lens barrels 260_1, 260_2 are positioned into the holes of the holder 230, respectively, and the compression coil spring 250_1/250_2 is between the lens barrel 260_1/260_2 and the holder 230. In this embodiment, each of the lens barrels 260_1, 260_2 has only one lens.

In the sixth step, a modulation transfer function (MTF) test is performed for adjusting a focus of the lens barrel 260_1. When adjusting the focus of the lens module 260_1, the lens barrel 260_1 is slid relative to the holder 230 (e.g. the lens module 260_1 is pressed to move down relative to the holder 230, and at this time the compression coil spring 250_1 exerts forces on the holder 230 and the lens barrel 260_1) to adjust a distance between the lens barrel 260_1 and the image sensor 220. After the lens barrel 260_1 is slid to an optimal position, ultraviolet ray is used to cure the UV-glue 242 between the lens barrel 260_1 and the holder 230 to fix the lens barrel 260_1 with the holder 230.

In the seventh step, a modulation transfer function (MTF) test is performed for adjusting a focus of the lens barrel 260_2. When adjusting the focus of the lens module 260_2, the lens barrel 260_2 is slid relative to the holder 230 (e.g. the lens module 260_2 is pressed to move down relative to the holder 230, and at this time the compression coil spring 250_2 exerts forces on the holder 230 and the lens barrel 260_2) to adjust a distance between the lens barrel 260_2 and the image sensor 220. After the lens barrel 260_2 is slid to an optimal position, ultraviolet ray is used to cure the UV-glue 242 between the lens barrel 260_2 and the holder 230 to fix the lens barrel 260_2 with the holder 230.

In the following steps, the other lens barrels are positioned into the other holes of the holder 230, and the focus of the lens barrels are adjusted by using the method described in the above-mentioned sixth step or seventh step.

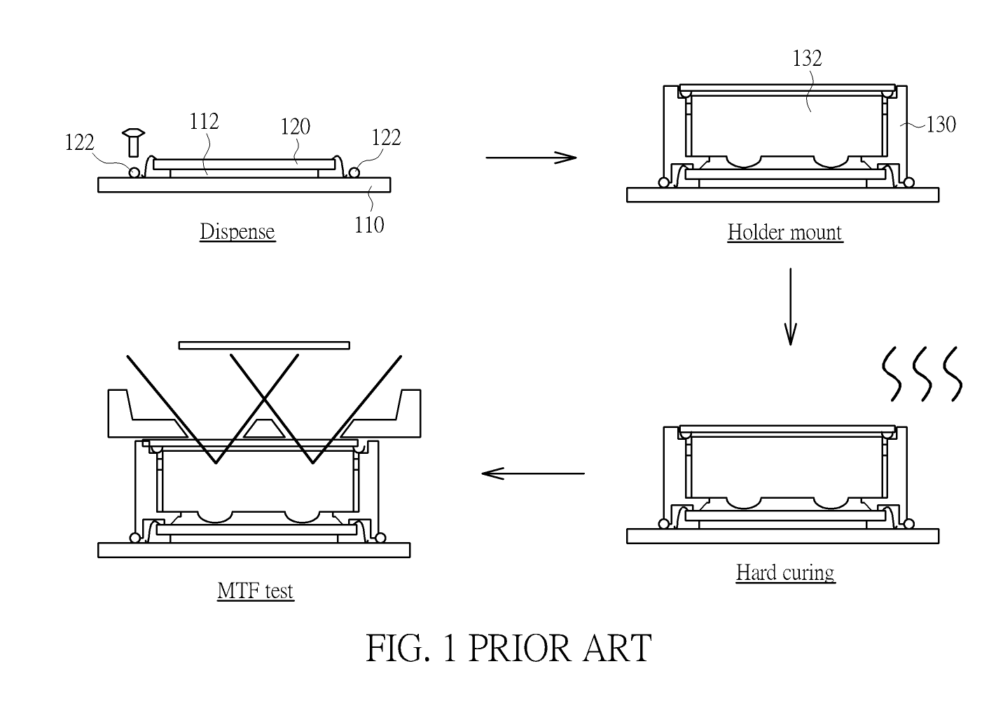

In light of above, because each of the lens barrels is performed focus adjust operation independently, when the holder 230 has the tilt issue relative to the PCB 210, by adjusting the positions of the lens barrels 260_1 and 260_2 independently, the focuses of the lens in the lens barrels 260_1 and 260_2 can be precisely on the image sensor 220. For example, assuming that the holder 230 has the tilt issue relative to the PCB 210, and the left side of the holder 230 is higher than the right side of the holder 230, the lens barrel 260_1 may be pressed deeper than the lens barrel 260_2, that is the compression degree of the compression coil spring 250_1 may be greater than that of the compression coil spring 250_2. Therefore, compared with the prior art focus adjust method shown in FIG. 1, the images sensed by the image sensing module of the present invention will be clear.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image sensing module, comprising:
a substrate;
an image sensor, mounted on the substrate;
a holder, positioned on the substrate;
a plurality of lens barrels, positioned in the holder, wherein each of the lens barrels holds a lens module; and
a plurality of elastic components, wherein each of the elastic components is positioned between the holder and the corresponding lens barrel, and exerting forces on the holder and the corresponding lens barrel.

2. The image sensing module of claim 1, wherein the lens module included in each of the lens barrels has only one lens.

3. The image sensing module of claim 1, wherein each of the elastic components is a spring.

4. The image sensing module of claim 1, wherein each of the elastic components is a compression coil spring.

5. The image sensing module of claim 1, wherein the lens barrels is fixed with the holder by using glue.

6. The image sensing module of claim 5, wherein the lens barrels is fixed with the holder by using ultraviolet rays glue (UV-glue).

7. The image sensing module of claim 1, wherein when the holder has a tilt issue relative to the substrate, a compression degree of one of the elastic components is different from a compression degree of the other one of the elastic components.

8. A method for adjusting a focus of an image sensor module, comprising:
providing a substrate;
providing an image sensor mounted on the substrate;
providing a holder positioned on the substrate;
putting a plurality of elastic components on holes of the holder;
positioning a plurality of lens barrels into the holes of the holder, respectively, to make each of the elastic components is positioned between the holder and the corresponding lens barrel, wherein each of the elastic components exerts forces on the holder and the corresponding lens barrel, and each of the lens barrels holds a lens module; and
sliding the lens barrels relative to the holder to adjust distances between the lens barrels and the image sensor, respectively, to adjusting the focus of the image sensor module.

9. The method of claim 8, wherein the lens module included in each of the lens barrels has only one lens.

10. The method of claim 8, wherein each of the lens barrels is slid to adjust the distance between the lens barrel and the image sensor independently.

11. The method of claim 8, wherein each of the elastic components is a spring.

12. The method of claim 8, wherein each of the elastic components is a compression coil spring.

13. The method of claim 8, further comprising:
before positioning the lens barrels into the holes of the holder, dispensing ultraviolet rays glue (UV-glue) on inner walls of the holes of the holder; and
after the lens barrels are slid to optimal positions, using ultraviolet rays to cure the UV-glue to fix the lens barrels with the holder.
